(19) United States
(12) Patent Application Publication
(10) Pub. No.: US 2026/0227765 A1
(43) Pub. Date: Aug. 6, 2026

(54) ANOMALY DETECTION AND ROOT CAUSE DIAGNOSIS

(71) Applicant: Honeywell International Inc., Charlotte, NC (US)

(72) Inventors: Viraj Srivastava, Bengaluru (IN); MeenakshiSundaram Krishnaswamy, Edmonton (CA); Qing Zhao, Edmonton (CA); JIABAO YAO, Edmonton (CA)

(21) Appl. No.: 19/043,545

(22) Filed: Feb. 3, 2025

(51) Int. Cl. G05B 19/418; G06F 16/901

(52) U.S. Cl. CPC G05B 19/4184; G06F 16/9024

(57) ABSTRACT

Approaches for detecting anomalies and diagnosing root causes in assets operating in OT environments are described. According to one example, a non-linear relationship between operational input and output variables of an asset is generated and a Directed Acyclic Graph (DAG) is created based on this relationship. Further, a prespecified Extreme Learning Machine (ELM) is implemented to generate non-linear inferences. The DAG identifies pairs of child-parent nodes, with child nodes associated with output variables and parent nodes with input variables. The ELM, trained on historical operational data, transfers behavioral uncertainties to child nodes. Further, anomalies are detected by identifying deviations in these uncertainties from normal operational behavior. For detected anomalies, a root node without a parent node is determined among the pairs of nodes. This invention provides a sophisticated approach to monitoring and maintaining assets in OT environments, potentially improving operational efficiency and reducing downtime.

### BACKGROUND

Industrial assets operating in Operational Technology (OT) environments generate vast amounts of operational data through various sensors and control systems. Asset reliability products analyze this time-series process and asset data to monitor asset health and performance. These products typically employ artificial intelligence (AI) and machine learning (ML) algorithms to establish benchmarks using historical fault-free data that represents normal process behavior.

This summary is provided to introduce concepts related to detecting anomalies and diagnosing root causes in assets, for example, industrial assets operating in OT environments. This summary is not intended to identify essential features of the claimed subject matter nor is it intended for use in determining or limiting the scope of the claimed subject matter.

In an aspect of the present subject matter, a system for detecting anomalies and diagnosing root causes in assets operating in OT environments is disclosed. The system includes an anomaly detection engine and a root cause diagnosis engine. The anomaly detection engine identifies cause-effect relationship within operational variables of an asset operating in an OT environment. Post that, the anomaly detection engine generates a Directed Acyclic Graph (DAG) for the asset based on the cause-effect relationship. The DAG is generated to identify a plurality of subsets of nodes. Each of the plurality of subsets of nodes identifies a subset of child-parent nodes. In each subset of child-parent nodes, a child node is associated with the operational output variables and the parent nodes are associated with the operational input variables. Further, the anomaly detection engine generates a non-linear inference using a prespecified Extreme Learning Machine (ELM). The prespecified ELM is used for transferring behavioral uncertainties on at least one child node present in the pair of child-parent nodes of each of the pairs of nodes. The prespecified ELM is trained on the non-linear plurality inference and historical operational data associated with a normal operational behavior of the asset. Once the non-linear inference is generated and the prespecified ELM is trained on the non-linear plurality inference and the historical operational data, the non-linear inference is parsed through the prespecified ELM for detecting the anomaly and the anomaly detection engine ascertains an anomaly in an operation of the asset on determining a deviation in the behavioral uncertainties of the at least one child node from the normal operational behavior of the asset. The root cause diagnosis engine determines a root node among the pairs of nodes for diagnosing root cause of the anomaly for at least one child node for which the anomaly is ascertained. Particularly, the root node is without a parent node.

In another aspect of the present subject matter, a method for detecting anomalies in assets operating in OT environments is disclosed. The method includes obtaining operational input variables corresponding to an asset operating in an Operational Technology (OT) environment and further obtaining operational output variables indicating an effect on the asset as a function of the operational input variables. After obtaining the cause-effect relationship between pairs of operational variables, the method includes estimating the non-linear relationship between each subset of operational variables that being determined to be input-output related. Further, in the method, a prespecified Extreme Learning Machine (ELM) generates a non-linear inference based on the non-linear relationship. The non-linear inference is to associate behavioral uncertainties at the operational output variables, wherein the prespecified ELM is trained on the non-linear inference and historical operational data associated with a normal operational behavior of the asset. Further, in the method, the non-linear inference is parsed through the prespecified ELM to determine deviations in the behavioral uncertainties from the historical operational data beyond a prespecified threshold for detecting an anomaly in the asset.

In yet another aspect of the present subject matter, a non-transitory computer readable medium for detecting anomalies and diagnosing root causes in assets operating in OT environments is disclosed. The non-transitory computer readable medium has instructions stored thereon. The instructions, when executed by a processor, cause the processor to perform operations. In the operations, the cause-effect relationship are determined within operational variables of an asset operating in an Operational Technology (OT) environment. Further, in the operations, a Directed Acyclic Graph (DAG) is generated for the asset based on the cause-effect relationship. The DAG identifies a plurality of subsets of nodes, each of the plurality of subsets of nodes identifies a pair of child-parent nodes. A child node in the pair of child-parent nodes is associated with the operational output variables, and a parent node in the pair of child-parent nodes is associated with the operational input variables. Further, in the operations, a prespecified Extreme Learning Machine (ELM) estimate a non-linear inference by transferring behavioural uncertainties on at least one child node present in the pair of child-parent nodes of each of the pairs of nodes. The prespecified ELM is trained on the non-linear plurality inference and historical operational data associated with a normal operational behavior of the asset. Further, in the operations, an anomaly in an operation of the asset is ascertained on determining a deviation in the behavioural uncertainties of the at least one child node from the normal operational behavior of the asset. The non-linear inference is parsed through the prespecified ELM for detecting the anomaly. Post anomaly detection, in the operations, for the at least one child node for which the anomaly is detected, a root node is determined among the pairs of nodes for diagnosing root cause of the anomaly provided that the root node is without a parent node.

### BRIEF DESCRIPTION OF FIGURES

Systems and/or methods are now described, in accordance with examples of the present subject matter and with reference to the accompanying figures, in which:

FIG. 1 illustrates a system for detecting anomalies and diagnosing root causes in assets operating in OT environments, according to an example;

FIG. 2 illustrates a system environment for detecting anomalies and diagnosing root causes in assets operating in OT environments, according to another example;

FIG. 3 illustrates a method for detecting anomalies in assets operating in OT environments, according to an example;

FIG. 4 illustrates generation of a Directed Acyclic Graph (DAG), according to an example;

FIG. 5 illustrates determination of anomaly pathway, according to an example;

FIG. 6 illustrates diagnosing root causes in assets operating in OT environments, according to an example;

FIG. 7 illustrates structural representation of input DAG, according to another example; and

FIG. 8 illustrates a computing environment implementing a non-transitory computer-readable medium for detecting anomalies and diagnosing root causes in assets operating in OT environments, according to an example.

### DETAILED DESCRIPTION

Various sensors and control systems generate vast amounts of operational data for industrial assets operating in Operational Technology (OT) environments. Further, asset reliability products analyze this time-series process and asset data to monitor asset health and performance. These products typically employ artificial intelligence (AI) and machine learning (ML) algorithms to establish benchmarks using historical fault-free data that represents normal process behavior. The algorithms then compare current operational states against these benchmarks to identify potential equipment failures or faults based on deviations from expected data ranges. Traditional monitoring approaches use multivariate pattern analysis to compare historical data patterns with current operational data for anomaly detection. System indicators may be calculated to help operators assess overall unit health and diagnose potential issues before unplanned trips occur.

However, existing approaches face several challenges. For example, warning systems may generate false positives or fail to detect actual faults with sufficient advance notice. Maintenance activities tend to be reactive or schedule-based rather than condition-based. The shortage of skilled personnel limits the ability to conduct thorough analysis and preserve institutional knowledge. Current solutions often rely on limited equipment condition data, providing an incomplete view of asset operation. Root cause analysis is time-consuming, requiring extensive review of data sheets, operational data, and maintenance records. Organizations lack unified views of relevant asset information from operating systems. Building reliable predictive models demands both domain expertise and data science knowledge. Additionally, traditional fault detection models using fixed thresholds cannot adapt to changing process behaviors and conditions.

Approaches for detecting anomalies and diagnosing root causes in assets, for example, industrial assets operating in OT environments are described. The present subject matter facilitates detection of complex non-linear relationships between operational variables of the assets that may not be captured by traditional linear models. Further, the present invention may adapt to changing process conditions through dynamic behavioral uncertainty analysis rather than relying on fixed thresholds.

According to an implementation of the present subject matter, a non-linear relationship between operational input variables and operational output variables of an asset may be generated. The non-linear relationship can be made adaptable to normal process condition changes as compared to conventional linear relationship. An OT environment refers to the hardware and software systems used to monitor and control physical processes, devices, and infrastructure in industrial settings. This includes manufacturing plants, power generation facilities, oil and gas refineries, and other industrial operations where physical equipment and processes are monitored and controlled. The operational input variables correspond to the asset operating in the OT environment and the operational output variables indicate an effect on the asset as a function of the operational input variables. In particular, the operational input variables refer to the various parameters and measurements collected from sensors, control systems, and other monitoring devices in the OT environment. This data represents the current state and operating conditions of the asset or process being monitored. Examples may include temperature readings, pressure measurements, flow rates, valve positions, and other process variables. On the other hand, the operational output variables represent the effects or results of the operational inputs on the asset or process. This could include performance metrics, quality indicators, energy consumption, production rates, or any other measurable outcomes that are influenced by the input parameters.

In an example, a probabilistic graphical model, such as a Bayesian Belief Network (BBN) or a Gaussian Bayesian Network (GBN), combined with a computationally effective single hidden layer feedward neural network, such as an Extreme Learning Machine (ELM), may be implemented for causality analysis in generating non-linear relationships. In many industrial processes, the relationship between input parameters and output results is not straightforward or linear. The non-linear relationship means that changes in input variables may have disproportionate or complex effects on the outputs. For example, doubling the input may not simply double the output, but could result in exponential growth, oscillations, or other complex behaviors.

Further, a Directed Acyclic Graph (DAG) may be generated for the asset based on these non-linear relationships for identifying pairs of child-parent nodes. Child nodes may be associated with operational output variables while parent nodes may be associated with operational input variables. The DAG is a graphical representation of the relationships between variables in the system. In the DAG, nodes represent variables, and directed edges between nodes represent causal or influential relationships. The DAG is "acyclic," meaning there are no closed loops or cycles in the relationships. The DAG may serve as a structural learning component of this model.

Further, a prespecified 4 mode Extreme Learning Machine (ELM) may be employed to generate a non-linear inference by transferring behavioral uncertainties to child nodes in the parent-child node pairs. The ELM may be trained using the non-linear inference and historical operational data representing normal operational behavior of the asset. In an example, the prespecified ELM can be selected from one of Sequential Domain-Adaptation Extreme Learning Machine (SDAELM), Domain Adaptation Extreme Learning Machine (DAELM), Sequential Regularized Extreme Learning Machine (SRELM), and Regularized Extreme Learning Machine (RELM) depending on problem statement.

Post generating the non-linear inference and receiving the behavioral uncertainties at the child nodes, anomalies may be ascertained by determining deviations in behavioral uncertainties of child nodes from normal operational behavior. In an example, the deviations in the behavioral uncertainties from the historical operational data beyond a prespecified threshold may be a criterion for detecting an anomaly in the operation of the asset. The non-linear inference may be parsed through the ELM for anomaly detection.

In an example, for nodes where anomalies are detected, root nodes among the node pairs may be determined to diagnose the root cause. Root nodes may be identified as nodes without parent nodes. In an example, the DAG may be generated to identify node pairs in a hierarchical order, with root nodes having the highest rank.

In an example, an Abnormal Likelihood Index (ALI) may be computed to quantify behavioral uncertainty deviations and a Dynamic Bayesian Contribution Index (DBCI) to analyze operational output variable contributions to anomalies. Candidate anomaly variables may be determined based on the DBCI.

The present invention provides several technical advantages over existing approaches. The combination of DAG-based structural learning and ELM enables detection of complex non-linear relationships between operational variables that may not be captured by traditional linear models. Further, the present invention may adapt to changing process conditions through dynamic behavioral uncertainty analysis rather than relying on fixed thresholds.

With the implementation of the present invention, root cause diagnosis may be accelerated by automatically identifying root nodes and analyzing anomaly pathways in the DAG structure. The integration of probabilistic graphical models with the ELM may enable more accurate anomaly detection while maintaining interpretability of the causal relationships between variables. The present invention may reduce false positives and provide earlier warning of developing issues by considering both historical normal behavior and non-linear operational relationships. The automated analysis of behavioral uncertainties and contribution indices may reduce reliance on manual expert analysis while providing actionable insights for maintenance planning.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

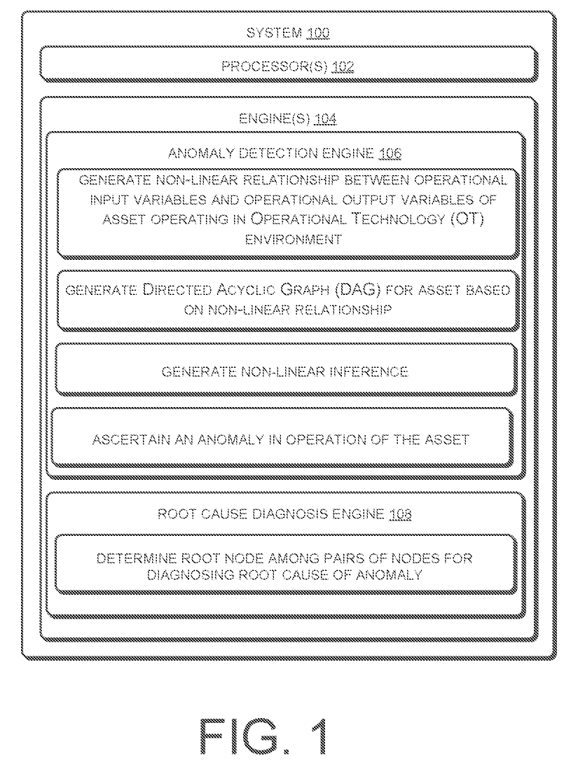

FIG. 1 illustrates a system 100 for detecting anomalies and diagnosing root causes in assets operating in OT environments, according to an example. The system 100 may be a device, such as an electronic device, that may be operated by the user for anomaly detection and root cause diagnosis. Examples of the electronic device may include, but are not limited to, a laptop, a desktop, a tablet computer, and a smart phone. The system 100 may be implemented in any computing system, such as a storage array, server, desktop or a laptop computing device, a distributed computing system, or the like. Although not depicted, the system 100 may include other components, such as interfaces to communicate over the network or with external storage or computing devices, display, input/output interfaces, operating systems, applications, data, and other software or hardware components (all of which have not been depicted).

In one example, the system 100 may be a standalone server or may be a remote server on a cloud computing platform. In a preferred example, the system 100 may be a cloud-based system. The system 100 is capable of delivering applications (such as cloud applications) for creating and executing queries on the data content. The cloud-based system allows for a scalable and flexible deployment of the system 100, enabling it to handle a large volume of queries and generate responses in a timely manner. The cloud-based implementation of the system 100 may also facilitate easy access to the system 100 by users from various locations and devices, thereby enhancing the usability and accessibility of the system 100.

In an example, the asset may be one of an industrial equipment, such as a boiler operating an oil and gas plant and a process, such as a welding process operating in a vehicle manufacturing plant. Examples of industrial equipment may include, but is not limited to, relief valves, blowdown valves, dampers, breakers. The OT environment is a system of hardware and software that manages, monitors, and controls industrial processes, devices, and events. The OT environment is used in many industries, including manufacturing, energy, utilities, and transportation.

The system 100 may include a processor 102. The processor 102 may be implemented as a dedicated processor, a shared processor, or a plurality of individual processors, some of which may be shared. The processor(s) 102 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labelled as “processor(s)”, may be provided through the use of dedicated hardware as well as hardware capable of executing computer-readable instructions.

The system 100 may further include engine(s) 104. The engine(s) 104 may be implemented as a combination of hardware and programming, for example, programmable instructions to implement a variety of functionalities of the engine(s) 104. In examples described herein, such combinations of hardware and programming may be implemented in several different ways. For example, the programming for the engine(s) 104 may be executable instructions. Such instructions may be stored on a non-transitory machine-readable storage medium which may be coupled either directly with the system 100 or indirectly (for example, through networked means). In an example, the engine(s) 104 may include a processing resource, for example, either a single processor or a combination of multiple processors, to execute such instructions. In other examples, the engine(s) 110 may be implemented as electronic circuitry. The engine(s) 104 includes an anomaly detection engine 106 and a root cause diagnosis engine 108.

In operation, the anomaly detection engine 106 of the system 100 generates a non-linear relationship between operational input variables and operational output variables of the asset operating in the Operational Technology (OT) environment. An operational input variable may be a parameter that influences the asset performance in a chosen output response. An operational output variable is an output response based on the operational input variable. The non-linear relationship is represented by a curve and in the non-linear relationship, data elements, such as the operational input variables and the operational output variables of the asset are attached in hierarchically manner. The anomaly detection engine 106 generates the non-linear relationship using either a Bayesian Belief Network (BBN) or a Gaussian Bayesian network (GBN).

During further operation, the anomaly detection engine 106 generates a Directed Acyclic Graph (DAG) for the asset based on the non-linear relationship. The DAG is a visual representation of the non-linear relationship between the operational input variables and the operational output variables of the asset and their connection to each other. The DAG is a key for processing and analysis The DAG is structured to identify multiple pairs of nodes, with each pair representing a child-parent relationship. For example, the DAG identifies a plurality of pairs of nodes, each of the plurality of pairs of nodes identifies a pair of child-parent nodes. A child node in the pair of child-parent nodes is associated with the operational output variables. A parent node in the pair of child-parent nodes is associated with the operational input variables. Specifically, it outlines the generation of a Directed Acyclic Graph (DAG) for an asset based on a non-linear relationship. In this structure, child nodes are associated with operational output variables and parent nodes are associated with operational input variables. This DAG structure is designed to model and represent complex relationships between input and output variables in an asset's operational data. The use of a DAG suggests a sophisticated approach to analyzing cause-and-effect relationships or dependencies within the system being described. The DAG forms a structural learning part of the BBN or the GBN.

The anomaly detection engine 106 further generates a non-linear inference by a prespecified Extreme Learning Machine (ELM). In an example, the prespecified ELM, includes, but is not limited to, Sequential Domain-Adaptation Extreme Learning Machine (SDAELM), Domain Adaptation Extreme Learning Machine (DAELM), Sequential Regularized Extreme Learning Machine (SRELM), and Regularized Extreme Learning Machine (RELM). The ELM is a type of machine learning algorithm that uses feedforward neural networks to perform a variety of tasks, including classification, regression, clustering, etc.

In particular, the present invention implements a specific ELM, such as Sequential Domain Adaptation Extreme Learning Machine (SDAELM) in place of a basic ELM model because this generates the following critical technical advantages. For example, the specific ELM adapts the concept of domain adaptation, which is particularly valuable in scenarios with limited data, such as for the anomaly detected based on the initial operational input data. The specific ELM can adapt to new environments with minimal data by leveraging data from related domains, improving robustness and accuracy. The sequential nature of the specific ELM enables online learning, allowing for real-time updates and adaptability in industrial applications. Such specific ELM based model can continuously learn and adjust as new data becomes available, maintaining relevance and effectiveness over time. The specific ELM offers flexibility through four different working modes (SDAELM, DAELM, SRELM, and RELM) by toggling sequential learning. This flexibility allows practitioners to choose the most suitable mode based on specific problem requirements, whether it requires full domain adaptation with sequential learning or a simpler regularized ELM. The invention emphasizes that the combination of these features with the hybrid ELM-BBN/GBN makes the invention uniquely capable of handling various fault diagnosis scenarios, particularly in complex and dynamic environments.

For generating the non-linear inference, the specific ELM assists the anomaly detection engine 106 to transfer behavioral uncertainties on a child node present in the pair of child-parent nodes of each of the pairs of nodes. The prespecified ELM may be trained on the non-linear plurality inference and historical operational data associated with a normal operational behavior of the asset. In an example, the non-linear inference may include a plurality of non-linear inferences generated for each of the pairs of nodes based on the transferred behavioral uncertainties. The non-linear inferences may refer to predictions or estimations that do not follow a straight-line relationship. The plurality of non-linear inferences may be aggregated to obtain an aggregated non-linear inference. The aggregating may involve combining or summarizing multiple inferences.

The anomaly detection engine 106 further ascertains an anomaly in operation of the asset on determining a deviation in the behavioral uncertainties of the at least one child node from the normal operational behavior of the asset. An "anomaly" may refer to a deviation from expected or normal behavior. For detecting the anomaly, the non-linear inference is parsed through the prespecified ELM. In an example, the aggregated non-linear inference may be compared with a predetermined threshold to determine the anomaly in the operational behavior of the asset. Accordingly, an alert signal indicative of the anomaly may be generated when the aggregated non-linear inference exceeds the predetermined threshold. The alert signal is a notification or warning of the detected anomaly.

Post anomaly ascertaining, the root cause diagnosis engine 108 is executed for diagnosing the root cause for the anomaly. For the child node for which the anomaly is ascertained, the root cause diagnosis engine 108 determines a root node among the pairs of nodes for diagnosing root cause of the anomaly. The root node is without a parent node. For determining the root node, the root cause diagnosis engine 108 then traverses through the pairs of nodes from the root node to the child node for which the anomaly is ascertained. This traversal allows the engine to analyze the relationships and dependencies between nodes, potentially identifying factors contributing to the anomaly.

During the traversal, the root cause diagnosis engine 108 may examine various attributes and metrics associated with each node. These may include performance indicators, configuration settings, resource utilization, and any other relevant data points that could provide insights into the anomaly's origin.

The root cause diagnosis engine 108 may employ advanced algorithms and heuristics to evaluate the likelihood of each traversed node being the root cause of the anomaly. This evaluation takes into account historical data, known patterns, and predefined rules specific to the system or application being monitored. As the traversal progresses, the root cause diagnosis engine 108 builds a probability map or score for each node, indicating its potential contribution to the anomaly. This allows for a more nuanced understanding of the problem, as multiple factors may be involved in causing or exacerbating the anomaly.

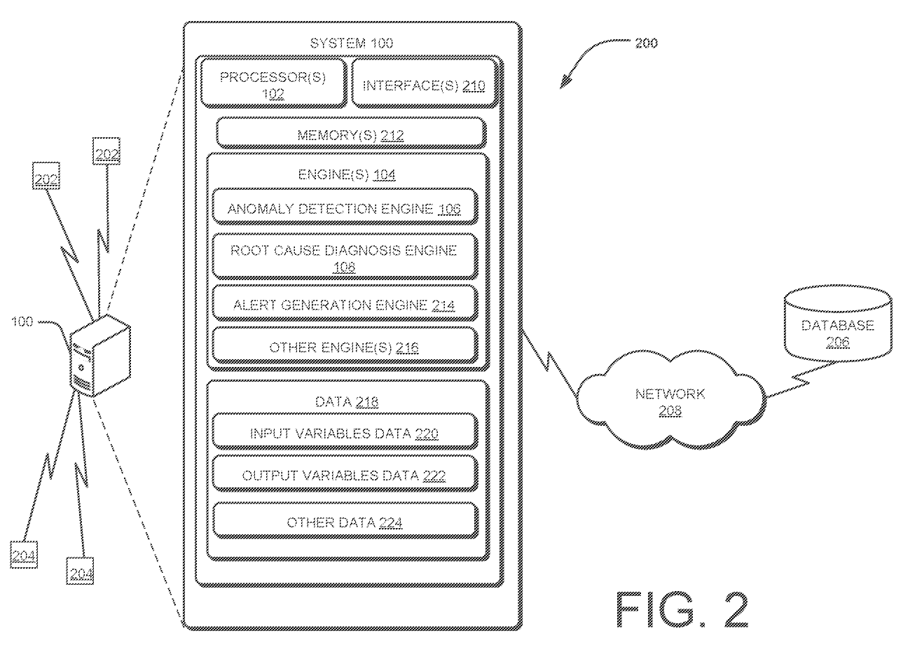

FIG. 2 illustrates a system environment 200 for detecting anomalies and diagnosing root causes in assets operating in OT environments, according to another example. The system environment 200 includes the system 100 for detecting anomalies and diagnosing root causes in assets operating in OT environments. The system 100 is described in FIG. 1 and may include, but is not limited to, a laptop, a notebook computer, a server computer, a tablet computer. The system 100 may include the processor(s) 102 similar to depicted in FIG. 1. In an example, the system 100 may be connected to a first sub-system 202 and a second sub-system 204, each having anomaly detection and root cause diagnosis modules (not shown). Further, in an example, the system 100 may be connected to a database 206 through a network 208. The database 206 may be, for example, a structured query language (SQL) data store or a not only SQL (NoSQL) data store. In an exemplary implementation, the database 206 may be configured as cloud-based database implemented in the software as a service environment. In another exemplary implementation, the database 206 may be a location on a file system directly accessible by the engines. The database 206 may be configured to store data of the assets and data of different variables and the like. The cloud-based implementation may also enable easy integration of the system 100 with other cloud-based services or systems, thereby expanding the capabilities and functionalities of the system 100. For example, the system 100 may be integrated with a cloud-based data analytics service to analyze the non-linear relationship between operational input variables and operational output variables and the non-linear inference, or with a cloud-based machine learning service to train and improve the prespecified Extreme Learning Machine.

The network 208 may be a wireless network, a wired network, or a combination thereof. The network 208 can also be an individual network or a collection of many such individual networks, interconnected with each other and functioning as a single large network, e.g., the Internet or an intranet. The network 208 can be implemented as one of the different types of networks, such as intranet, local area network (LAN), wide area network (WAN), the internet, and such. The network 208 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other.

In one implementation, the system environment 200 may be an artificial intelligence based network, including personal computers, laptops, various servers, such as blade servers, and other computing devices connected over the network 208. The system 100 includes the processor(s) 102. Further, the system 100 includes interface(s) 210 and memory(s) 212. The interface(s) 210 may allow the connection or coupling of the system 100 with one or more other devices, through a wired (e.g., Local Area Network, i.e., LAN) connection or through a wireless connection (e.g., Bluetooth®, Wi-Fi). The interface(s) 210 may also enable intercommunication between different logical as well as hardware components of the system 100.

The memory(s) 212 may be a computer-readable medium, examples of which include volatile memory (e.g., RAM), and/or non-volatile memory (e.g., Erasable Programmable read-only memory, i.e., EPROM, flash memory, etc.). The memory(s) 212 may be an external memory, or internal memory, such as a flash drive, a compact disk drive, an external hard disk drive, or the like. The memory(s) 212 may further include data which either may be utilized or generated during the operation of the system 100.

The engine(s) 104 of the system 100 may further include an alert generation engine 214 and other engines 216 in addition to the anomaly detection engine 106 and the root cause diagnosis engine 108 as depicted in FIG. 1. The alert generation engine 214, the other engines 216, the anomaly detection engine 106, and the root cause diagnosis engine 108 may be implemented as a combination of hardware and programming, for example, programmable instructions to implement a variety of functionalities of the engine(s). In examples described herein, such combinations of hardware and programming may be implemented in several different ways. For example, the programming for the engine(s) may be executable instructions. Such instructions may be stored on a non-transitory machine-readable storage medium which may be coupled either directly with the system 100 or indirectly (for example, through networked means). In an example, the engine(s) may include a processing resource, for example, either a single processor or a combination of multiple processors, to execute such instructions. In other examples, the engine(s) may be implemented as electronic circuitry. The system 100 may further include data 218. The data 218 may further include input variables data 220, output variables data 222, and other data 224.

The system environment 200 is in operation once an asset operates in an industrial environment, particularly an Operational Technology (OT) environment, since asset health and performance are important parameters for an efficient operation of the asset in the OT environment. The OT environment refers to the hardware and software systems used to monitor and control physical processes, devices, and infrastructure in various industries such as manufacturing, energy, transportation, and utilities. OT environments typically involve industrial control systems, supervisory control and data acquisition (SCADA) systems, and other specialized equipment used to manage and operate industrial processes. The system environment 200 utilizes advanced machine learning techniques to detect anomalies and identify their root causes in complex industrial systems.

The engines 104 of the system environment 200 work together to identify abnormal behavior in the asset and determine the underlying causes of such anomalies. In particular, the anomaly detection engine 106 of the system 100 performs several key functions for the anomaly detection including generation of a non-linear relationship between operational input variables and operational output variables of an asset. For this, the anomaly detection engine 106 establishes the non-linear relationship between operational input variables and operational output variables of an asset. Operational input variables are the parameters or conditions that affect the asset's operation, such as temperature, pressure, or voltage. Operational output variables are the measurable results or effects of the asset's operation, such as production rate, energy consumption, or product quality. The non-linear relationship is represented by a curve and in the non-linear relationship, data elements, such as the operational input variables and the operational output variables of the asset are attached in hierarchically manner.

In an example, the anomaly detection engine 106 implements a specific probabilistic graphical model to perform a causality analysis for generating the non-linear relationship between the operational input variables and the operational output variables. This probabilistic graphical model is designed to capture complex dependencies and interactions among multiple variables in the system. By utilizing this approach, the anomaly detection engine 106 can effectively represent and analyze the causal relationships between various operational parameters. The model incorporates Bayesian networks to represent the joint probability distribution of the variables. This allows for the encoding of domain knowledge and the ability to handle uncertainty in the data. The causality analysis performed by the model helps identify the root causes of anomalies by tracing the propagation of effects through the network of variables.

To generate the non-linear relationship between operational input and output variables, the anomaly detection engine 106 may employ techniques such as non-linear regression methods (e.g., polynomial regression, spline regression), kernel-based methods (e.g., support vector regression), neural network architectures (e.g., multilayer perceptrons, recurrent neural networks). These techniques enable the capture of complex, non-linear patterns in the data that may not be apparent through traditional linear analysis methods. The probabilistic graphical model also incorporates learning algorithms to adapt and improve its performance over time. This may include parameter estimation techniques like maximum likelihood estimation or Bayesian inference, as well as structure learning algorithms to discover the optimal graph structure representing the causal relationships.

By leveraging this sophisticated probabilistic graphical model, the anomaly detection engine 106 can identify hidden patterns and relationships in the operational data, quantify the strength and direction of causal influences between variables, make predictions about system behavior under various conditions, detect anomalies that deviate from the learned causal structure, provide interpretable insights into the underlying mechanisms driving system performance. This approach enhances the engine's ability to detect subtle anomalies, reduce false positives, and provide actionable insights for system optimization and maintenance. In an example, the probabilistic graphical model is one of a Bayesian Belief Network (BBN) and a Gaussian Bayesian network (GBN).

The anomaly detection engine 106 employs a hybrid approach combining Bayesian networks (BBN or GBN) with a specific Extreme Learning Machines (ELM) to achieve robust and adaptive anomaly detection. This hybrid approach leverages the strengths of both probabilistic graphical models and neural networks, allowing for efficient handling of uncertainties and non-linear relationships in complex operational environments. In an example, the anomaly detection engine 106 generates the non-linear relationship using either a Bayesian Belief Network (BBN) or a Gaussian Bayesian network (GBN). While Bayesian Belief Networks (BBN) and Gaussian Bayesian Networks (GBN) are used for causality analysis, other probabilistic graphical models could be incorporated. For instance, Markov Random Fields (MRFs) or Conditional Random Fields (CRFs) could be used, especially in scenarios where undirected graphical models might be more appropriate for representing the relationships between variables in the OT environment. In an example, any probabilistic graphical model that shows the relationships between variables in a system using a directed acyclic graph can be implemented. The anomaly detection engine 106 could utilize different machine learning algorithms for generating the non-linear relationship between operational input and output variables. While the current invention specifies an Extreme Learning Machine (ELM), alternative algorithms such as Support Vector Machines (SVMs), Random Forests, or Deep Neural Networks could be employed. Each of these algorithms has unique strengths in handling non-linear relationships and could potentially offer improved performance in certain scenarios or with specific types of data.

Based on the non-linear relationship, the anomaly detection engine 106 may generate a Directed Acyclic Graph (DAG) for the asset. A Directed Acyclic Graph is a graphical representation of the relationships between variables, where edges indicate the direction of influence, and there are no cycles in the graph. In this context, the DAG identifies pairs of child-parent nodes, where child nodes are associated with operational output variables, and parent nodes are associated with operational input variables. A child node in the pair of child-parent nodes is associated with the operational output variables. A parent node in the pair of child-parent nodes is associated with the operational input variables. This DAG structure is designed to model and represent complex relationships between input and output variables in an asset's operational data. The use of a DAG suggests a sophisticated approach to analyzing cause-and-effect relationships or dependencies within the system being described. The DAG forms a structural learning part of the BBN or the GBN. The use of a Directed Acyclic Graph (DAG) provides a clear visual representation of the causal relationships between operational input and output variables. This structure not only aids in understanding the asset's behavior but also facilitates efficient inference and anomaly detection processes. The DAG's hierarchical arrangement of nodes enables the system to capture and analyze complex dependencies that may not be apparent in traditional linear models.

In an example, the anomaly detection engine 106 generates the DAG for identifying the plurality of pairs of nodes in a hierarchical order representing the root node with highest rank. For this, the anomaly detection engine 106 analyzes the generated DAG to identify relationships between nodes and determine the hierarchical structure. Each node in the DAG represents a specific data point or a feature, while edges between nodes indicate dependencies or correlations. The anomaly detection engine 106 employs various algorithms to traverse the DAG and evaluate node importance. It considers factors such as node connectivity, centrality measures, and domain-specific relevance to assign ranks to individual nodes. The root node, positioned at the top of the hierarchy, is identified as the node with the highest rank based on these criteria. As the anomaly detection engine 106 progresses through the DAG, it identifies pairs of nodes that are directly connected or closely related within the hierarchical structure. These pairs are organized in descending order of importance, with pairs closer to the root node generally having higher priority. This hierarchical ordering of node pairs enables the anomaly detection system to focus on the most significant relationships and patterns within the data. The anomaly detection engine 106 may also incorporate techniques such as pruning or filtering to refine the DAG and remove less relevant or redundant connections. This optimization process enhances the efficiency and accuracy of anomaly detection by concentrating on the most informative node pairs and relationships.

By leveraging the hierarchical structure of the DAG and the ranked pairs of nodes, the anomaly detection engine 106 can more effectively identify unusual patterns, outliers, or deviations from expected behavior within the analyzed data set. This approach allows for a more nuanced and context-aware anomaly detection process, taking into account the complex interdependencies and hierarchical relationships present in the data.

In an example, the DAG may be generated by implementing a data-based DAG learning model. The data-based DAG learning model is to implement time-series discretization techniques for use of the DAG in categorical datasets. The data-based DAG learning model includes components such as an Equal Width Discretization (EWD) module, a Hill Climb (HC) search algorithm, and a Bayesian Information Criterion (BIC) scoring module.

In an example, the time-series discretization techniques include converting continuous time-series data into discrete categorical data by dividing the continuous data into intervals or bins, assigning categorical labels to each interval or bin based on predefined criteria or statistical properties of the data, applying temporal abstraction methods to reduce the dimensionality of the time-series data while preserving relevant temporal patterns, implementing symbolic aggregate approximation (SAX) to transform the time-series data into a sequence of symbols, enabling efficient pattern discovery and similarity search, utilizing piecewise aggregate approximation (PAA) to segment the time-series data into fixed-length intervals and represent each interval by its mean value, employing adaptive discretization techniques that adjust the bin sizes or interval boundaries based on the distribution and characteristics of the time-series data, and integrating domain-specific knowledge to guide the discretization process and ensure meaningful categorization of the time-series data for use in the DAG learning model.

The anomaly detection engine 106 further generates a non-linear inference by a prespecified Extreme Learning Machine (ELM). In an example, the prespecified ELM, includes, but is not limited to, Sequential Domain-Adaptation Extreme Learning Machine (SDAELM), Domain Adaptation Extreme Learning Machine (DAELM), Sequential Regularized Extreme Learning Machine (SRELM), and Regularized Extreme Learning Machine (RELM). The ELM is a type of machine learning algorithm that uses feedforward neural networks to perform a variety of tasks, including classification, regression, clustering, etc. The implementation of specific ELM variants, particularly the Sequential Domain Adaptation Extreme Learning Machine (SDAELM), addresses key challenges in industrial anomaly detection. These challenges include limited initial data, the need for real-time adaptability, and the requirement to generalize across different operational domains. The SDAELM's ability to perform online learning and adapt to new environments with minimal data makes it particularly suited for dynamic industrial settings where operational conditions may frequently change.

In an example, the anomaly detection engine 106 may normalize the non-linear relationship using the prespecified ELM to represent predicted operational condition of the asset. The normalization process involves scaling and transforming the input data to a common range or distribution, thereby facilitating more accurate and efficient analysis of the asset's operational state. The normalized non-linear relationship is used to generate a predictive model that forecasts future operational conditions of the asset based on current and historical data, enabling proactive maintenance and optimization of asset performance.

In particular, the present invention implements a specific ELM in place of a basic ELM model because this generates the following critical technical advantages. For example, the specific ELM adapts the concept of domain adaptation, which is particularly valuable in scenarios with limited data, such as for the anomaly detected based on the initial operational input data. The specific ELM can adapt to new environments with minimal data by leveraging data from related domains, improving robustness and accuracy. The sequential nature of the specific ELM enables online learning, allowing for real-time updates and adaptability in industrial applications. Such specific ELM based model can continuously learn and adjust as new data becomes available, maintaining relevance and effectiveness over time. The specific ELM offers flexibility through four different working modes (SDAELM, DAELM, SRELM, and RELM) by toggling sequential learning. This flexibility allows practitioners to choose the most suitable mode based on specific problem requirements, whether it requires full domain adaptation with sequential learning or a simpler regularized ELM. The invention emphasizes that the combination of these features with the hybrid ELM-BBN/GBN makes the invention uniquely capable of handling various fault diagnosis scenarios, particularly in complex and dynamic environments.

For generating the non-linear inference, the specific ELM assists the anomaly detection engine 106 to transfer behavioral uncertainties on a child node present in the pair of child-parent nodes of each of the pairs of nodes. Behavioral uncertainties refer to the variability or unpredictability in the asset's behavior under different operating conditions. In the present context, such uncertainties may be associated with the nodes in the model representing operational output data. By capturing and modeling these uncertainties, the system environment 200 can better account for normal variations in the process and distinguish between expected fluctuations and genuine anomalies. The prespecified ELM may be trained on the non-linear plurality inference and historical operational data associated with a normal operational behavior of the asset. Normal operational behavior refers to the expected range of values and patterns observed in the asset or process when it is functioning correctly and efficiently. This baseline is established using historical operational data collected during periods of known good performance. The transfer of the behavioral uncertainties from parent nodes to child nodes in the DAG allows for a more nuanced and context-aware anomaly detection process. This transfer of uncertainties, facilitated by the ELM, enables the system to consider the propagation of potential anomalies through the asset's operational structure, leading to more accurate and interpretable results.

In an example, the behavioral uncertainties may be associated at the operational output variables, by the prespecified ELM, through prediction intervals generated by a sampling technique. The sampling technique involves generating multiple samples of the input variables based on their probability distributions. These samples are then propagated through the prespecified ELM to obtain corresponding output samples. The prediction intervals are derived from the statistical analysis of these output samples, providing a range of possible values for the operational output variables with a specified level of confidence. The prediction intervals account for various sources of uncertainty, including measurement errors, model approximations, and inherent variability in the system. By quantifying these uncertainties, decision-makers can better understand the reliability and robustness of the ELM predictions, enabling more informed operational decisions and risk assessments. The width of the prediction intervals reflects the degree of uncertainty associated with the ELM's predictions. Narrower intervals indicate higher confidence in the predicted values, while wider intervals suggest greater uncertainty. This information is crucial for assessing the reliability of the ELM's outputs and for identifying areas where additional data or model refinement may be necessary to improve prediction accuracy.

In an example, the non-linear inference may include a plurality of non-linear inferences generated for each of the pairs of nodes based on the transferred behavioral uncertainties. The plurality of non-linear inferences may be aggregated to obtain an aggregated non-linear inference. The aggregating may involve combining or summarizing multiple inferences. The aggregation of multiple non-linear inferences into a single metric provides a comprehensive view of the asset's operational state. This aggregation process allows for the consideration of complex interactions between different operational aspects, resulting in a more holistic approach to anomaly detection. The comparison of this aggregated inference against a predetermined threshold offers a clear and actionable decision point for identifying anomalies.

In an example, the probabilistic graphical model is embedded with the prespecified ELM for anomaly detection. The probabilistic graphical model incorporates prior knowledge and statistical dependencies between variables, while the extreme learning machine (ELM) provides fast and efficient learning capabilities. This combination allows for robust anomaly detection by leveraging the strengths of both approaches. The embedded structure enables the system to capture complex relationships in the data, adapt to changing patterns, and identify anomalies with high accuracy and low computational overhead. The integration of the probabilistic graphical model with the ELM also facilitates interpretability of the anomaly detection results, as the graphical structure can provide insights into the underlying factors contributing to the identified anomalies.

In an example, the anomaly detection engine 106 may implement the DAG as a structural learning component of the probabilistic graphical model. In an example, the structural learning component is configured to identify causal relationships between variables in the system 100 and further determine conditional dependencies among the variables based on the identified causal relationships. Accordingly, the DAG may be generated by representing the variables as nodes and the conditional dependencies as directed edges between the nodes and the DAG may be updated dynamically as new data is received or system conditions change. The DAG may be utilized to infer probabilistic relationships and dependencies within the system 100 and further optimize the structure of the DAG to improve computational efficiency and accuracy of anomaly detection. Also, the DAG may be integrated with other components of the probabilistic graphical model to enhance overall system performance and reliability.

When the non-linear inference is generated, the anomaly detection engine 106 may ascertain an anomaly in operation of the asset on determining a deviation in the behavioral uncertainties of the at least one child node from the normal operational behavior of the asset. The anomaly is a deviation from expected or normal behavior. For detecting the anomaly, the non-linear inference is parsed through the prespecified ELM. In an example, the aggregated non-linear inference may be compared with a predetermined threshold to determine the anomaly in the operational behavior of the asset. The anomaly detection is the process of identifying unusual patterns or behaviors in the system that deviate significantly from the expected normal operational behavior. In this invention, anomalies are detected by comparing the current behavioral uncertainties, as inferred by the specific ELM, against the historical data and predefined thresholds.

The anomaly detection engine 106 may compute an Abnormal Likelihood Index (ALI) to quantify the deviation in the behavioral uncertainties from the normal operational behavior of the asset and further compute a Dynamic Bayesian Contribution Index (DBCI) to analyze contributions of the operational output variables to the anomaly. The Abnormal Likelihood Index (ALI) is a quantitative measure that assesses the degree of deviation in behavioral uncertainties from the asset's normal operational state. The ALI is computed using statistical methods to compare current operational data against established baseline patterns. The Dynamic Bayesian Contribution Index (DBCI) is probabilistic metric that evaluates the relative contributions of various operational output variables to an observed anomaly. The DBCI is calculated using Bayesian inference techniques, allowing for dynamic updating of probabilities as new data becomes available. The anomaly detection engine 106 may determine a set of the operational output variables as candidate anomaly variables based on the DBCI. The set is associated with child nodes present in the plurality of pairs of nodes. The candidate anomaly variables may be a subset of operational output variables identified based on their DBCI values, indicating a high likelihood of being associated with the detected anomaly. These variables correspond to child nodes in the DAG representation.

Further, the alert generation engine 214 may generate an alert signal indicative of the anomaly may be generated when the aggregated non-linear inference exceeds the predetermined threshold. The alert signal is a notification or warning of the detected anomaly. The alert generation engine 214 ability to generate alert signals based on detected anomalies enables proactive maintenance and operational management. These alerts can be integrated into existing industrial control and monitoring systems, allowing for timely interventions to prevent potential failures or operational disruptions. The flexibility of the alert mechanism can be tailored to different severity levels or types of anomalies, enhancing the system's utility across various industrial applications.

The anomaly detection engine 106 and root cause diagnosis engine 108 employ sophisticated statistical and probabilistic methods to identify and analyze anomalies in the operational behavior of an asset.

Post anomaly ascertaining, the root cause diagnosis engine 108 is executed for diagnosing the root cause for the anomaly. For the child node for which the anomaly is ascertained, the root cause diagnosis engine 108 determines a root node among the pairs of nodes for diagnosing root cause of the anomaly. The root node is without a parent node. That is to say, a root node is a node in the DAG that has no parent nodes, representing a fundamental input variable that is not influenced by other variables in the model. During the root cause diagnosis, the fundamental source or origin of an observed anomaly or problem is identified. In this system 100, root cause diagnosis is performed by tracing back through the DAG structure to identify the parent nodes (variables) that are most likely responsible for the observed deviation in a child node.

For the root cause diagnosis, the root cause diagnosis engine 108 may determine an anomaly pathway from the DAG. The anomaly pathway represents a sequence of connected nodes in the DAG that represents the propagation of an anomaly through the system, from root causes to observable effects. The determination is done by firstly identifying root nodes without parent nodes as immediate candidates for anomaly. Further, for the candidate anomaly variables with parent nodes, the root cause diagnosis engine 108 determines potential fault pathways to identify root nodes. The determination of the potential fault pathways is the determination of potential routes through the DAG that an anomaly may follow, starting from candidate anomaly variables and tracing back to root nodes.

The root cause diagnosis engine 108 employs these concepts to systematically analyze the DAG structure, identifying potential sources of anomalies and tracing their propagation through the system. This approach enables efficient and accurate identification of root causes, facilitating targeted interventions and maintenance actions.

By combining these elements, i.e., DAG, BBN, GBN, ELM, the system 100 provides a powerful and flexible approach to monitoring complex industrial processes, detecting anomalies early, and quickly identifying root causes of issues. This enables more efficient maintenance, reduced downtime, and improved overall performance of assets in OT environments.

Also, the root cause diagnosis engine 108 utilizes a combination of statistical analysis, machine learning techniques, and domain-specific knowledge to refine its diagnosis. This multi-faceted approach enables the engine to handle complex scenarios where the root cause may not be immediately apparent or may be the result of multiple interacting factors.

In an example, for determining the root node, the root cause diagnosis engine 108 then traverses through the pairs of nodes from the root node to the child node for which the anomaly is ascertained. This traversal allows the engine to analyze the relationships and dependencies between nodes, potentially identifying factors contributing to the anomaly. During the traversal, the root cause diagnosis engine 108 may examine various attributes and metrics associated with each node. These may include performance indicators, configuration settings, resource utilization, and any other relevant data points that could provide insights into the anomaly's origin.

In addition to traversing the DAG, the root cause diagnosis engine 108 may also consider temporal aspects of the data. It analyzes time-series information to identify any patterns or trends that preceded the anomaly. This temporal analysis can reveal important insights into the sequence of events that led to the anomalous behavior, helping to pinpoint the root cause more accurately.

The root cause diagnosis engine 108 may employ advanced algorithms and heuristics to evaluate the likelihood of each traversed node being the root cause of the anomaly. This evaluation takes into account historical data, known patterns, and predefined rules specific to the system or application being monitored. As the traversal progresses, the root cause diagnosis engine 108 builds a probability map or score for each node, indicating its potential contribution to the anomaly. This allows for a more nuanced understanding of the problem, as multiple factors may be involved in causing or exacerbating the anomaly.

The root cause diagnosis engine 108 may also incorporate feedback mechanisms to continuously improve its diagnostic capabilities. As it processes more cases and receives feedback on the accuracy of its diagnoses, it refines its algorithms and heuristics. This adaptive learning approach ensures that the system becomes increasingly effective over time, especially in dealing with recurring or similar types of anomalies.

To enhance the accuracy of root cause diagnosis, the root cause diagnosis engine 108 may employ ensemble methods, combining the outputs of multiple diagnostic algorithms. This approach helps to mitigate the limitations of any single method and provides a more robust and reliable diagnosis. The root cause diagnosis engine 108 is designed to handle uncertainty and incomplete information. It uses probabilistic reasoning techniques to make inferences even when some data points are missing or unreliable. This capability is particularly valuable in real-world scenarios where perfect information is rarely available.

Once the root cause is identified, the root cause diagnosis engine 108 may generate a detailed report outlining its findings. This report includes the identified root cause, the confidence level of the diagnosis, the path of traversal through the DAG, key contributing factors, and any relevant supporting data or visualizations. This comprehensive output aids in quick decision-making and effective problem resolution.

The root cause diagnosis engine 108 may include a recommendation module that suggests potential corrective actions based on the diagnosed root cause. These recommendations are derived from a knowledge base of best practices, historical resolutions, and domain-specific guidelines. This feature assists operators in taking prompt and appropriate actions to address the anomaly and prevent its recurrence.

To further enhance its capabilities, the root cause diagnosis engine 108 can integrate with external data sources and systems. This integration allows it to consider a wider range of factors that might influence the asset's behavior, such as environmental conditions, maintenance schedules, or even data from similar assets in different locations.

The root cause diagnosis engine 108 is designed with scalability in mind, capable of handling multiple assets and complex systems simultaneously. It can prioritize and manage multiple anomalies based on their severity and potential impact, ensuring that the most critical issues are addressed first.

The root cause diagnosis engine 108 may incorporate additional techniques beyond the current approach. For example, it could implement a fuzzy logic-based system to handle uncertainties in the diagnosis process or incorporate a case-based reasoning approach that learns from historical anomaly cases to improve diagnosis accuracy over time.

The implementation of the SDAELM provides several key advantages over traditional ELM models, such as enhanced performance in limited data scenarios. By incorporating domain adaptation techniques, the SDAELM can effectively leverage knowledge from related domains, allowing it to perform well even when training data in the target domain is scarce. The domain adaptation capability enables SDAELM to better generalize across different but related domains, making it more robust to variations in input data and environmental conditions. The sequential nature of SDAELM allows for continuous updates to the model as new data becomes available, ensuring that the model remains relevant and accurate in dynamic environments. By building upon the ELM framework, SDAELM maintains the computational efficiency of ELM while incorporating advanced features like domain adaptation and sequential learning. The combination of SDAELM with the hybrid ELM-BN pipeline enhances the overall accuracy and reliability of fault diagnosis in complex systems, particularly in industrial applications where early detection and precise identification of faults are crucial. The continuous learning capability of SDAELM allows it to adapt to evolving system behaviors and environmental changes, making it particularly suitable for long-term deployment in industrial settings. By leveraging domain adaptation techniques, the SDAELM can adapt to new environments or slightly modified systems without requiring a complete retraining of the model, saving time and computational resources.

The integration with Bayesian Networks in the hybrid ELM-BN pipeline provides a probabilistic framework that can enhance the interpretability of the fault diagnosis results, allowing for better decision-making in critical situations. The flexible architecture of SDAELM allows it to be scaled to handle increasingly complex systems and larger datasets, making it suitable for a wide range of applications from small-scale processes to large industrial systems.

These advantages position the SDAELM-based invention as a powerful and versatile tool for fault diagnosis and potentially other machine learning applications in industrial and scientific domains. Its ability to adapt, learn continuously, and maintain high performance in challenging conditions makes it a significant improvement over traditional ELM models and other existing fault diagnosis techniques. This capability ensures that the model can continuously learn and adjust as new data becomes available, maintaining its relevance and effectiveness over time.

The system 100 could incorporate various data preprocessing techniques to enhance the quality of input data. This could include advanced noise reduction algorithms, feature selection methods like Principal Component Analysis (PCA) or Independent Component Analysis (ICA), or data augmentation techniques to handle imbalanced datasets often encountered in anomaly detection scenarios.

In an example, the anomaly detection engine 106 and the root cause diagnosis engine 108 may be designed with different integration capabilities. For instance, it could include APIs for seamless integration with existing SCADA systems, IoT platforms, or enterprise resource planning (ERP) software. This would allow for real-time data ingestion and anomaly reporting across various industrial control systems and business processes. In addition, with the implementation of the system 100, training may be enabled in a single step instead of iterative training such as back propagation.

In an example implementation, the GBN incorporating ELM may be implemented. The purpose of this implementation is to replace linear regression in the GBN-based algorithm to better capture non-linear relationships between process parameters. In this example, for each child node in the DAG representing process variables, an ELM model with prediction intervals is used instead of a traditional GBN linear regression model. Said implementation includes a training phase and a testing phase. In the training phase, the training data is resampled using Bootstrap techniques, creating multiple subsets. Further, an ensemble of ELM models (Bootstrap ELMs) is trained on these subsets to capture variability in the process data. This helps account for uncertainties in input variables (parent nodes), which are propagated through to the predicted output (child nodes). In the testing phase, the ensemble predictions are aggregated to compute the mean and variance for each child node. These statistics form a Gaussian probability distribution, providing a more accurate representation of the expected output considering non-linearities.

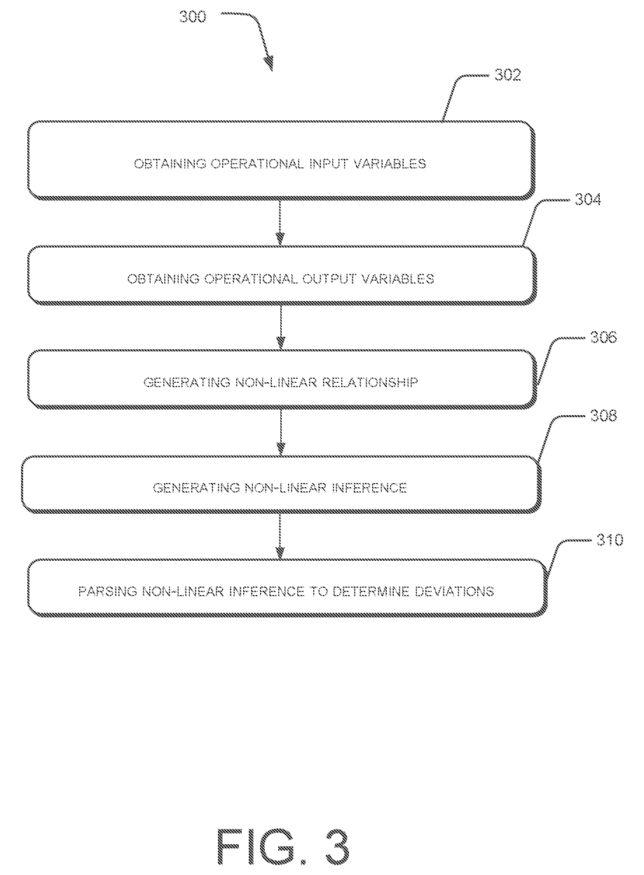

FIG. 3 illustrates a method for detecting anomalies in assets operating in OT environments, according to an example. The order in which the method 300 is described is not intended to be construed as a limitation, and any number of the described method blocks may be combined in any order to implement the methods, or an alternative method. Further, the method 300 may be implemented by processing resource or computing device(s) through any suitable hardware, non-transitory machine-readable instructions, or combination thereof.

It may also be understood that method 300 may be performed by programmed computing devices, such as the system 100, as depicted in FIG. 1 and FIG. 2. Furthermore, the method 300 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the method 300 is described below with reference to the system 100 as described above; other suitable systems for the execution of said method may also be utilized. Additionally, implementation of the method is not limited to such examples.

At block 302, the method includes obtaining operational input variables corresponding to an asset operating in an Operational Technology (OT) environment. This is done as a stepping stone in detecting abnormal asset behavior. The anomaly detection engine 106, a key component of the system 100, plays a crucial role in this process by obtaining the operational input variables that may include factors like temperature, pressure, or voltage. The operational input variables are the parameters or conditions that affect the asset's operation.

At block 304, the method includes obtaining operational output variables indicating an effect on the asset as a function of the operational input variables. The anomaly detection engine 106 may obtain the operational input variables encompassing, for example, production rate, energy consumption, or product quality. The operational output variables are the measurable results or effects of the asset's operation.

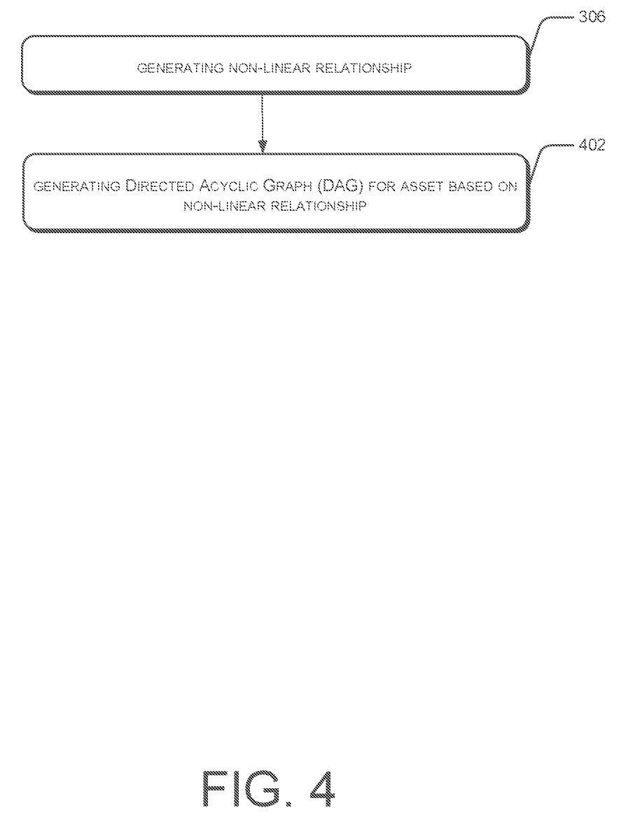

At block 306, the method includes generating a non-linear relationship between the operational variables and the operational output variables. The anomaly detection engine 106, a key component of the system 100, plays a crucial role in this process by generating the non-linear relationship between an asset's operational input and output variables. This relationship is established by the anomaly detection engine 106, linking parameters that influence asset operation (input variables) with measurable outcomes of that operation (output variables). The non-linear relationship is visually represented as a curve, with data elements such as input and output variables arranged in a hierarchical structure. A probabilistic graphical model may be implemented to perform a causality analysis for generating the non-linear relationship between the operational input variables and the operational output variables. This probabilistic graphical model is designed to capture complex dependencies and interactions among multiple variables in any system. In an example, the probabilistic graphical model incorporates Bayesian networks to represent the joint probability distribution of the variables. The causality analysis performed by the model helps identify the root causes of anomalies by tracing the propagation of effects through the network of variables. In an example, the probabilistic graphical model is one of a Bayesian Belief Network (BBN) and a Gaussian Bayesian network (GBN). Based on the non-linear relationship, a Directed Acyclic Graph (DAG) may be generated for the asset as illustrated in FIG. 4.

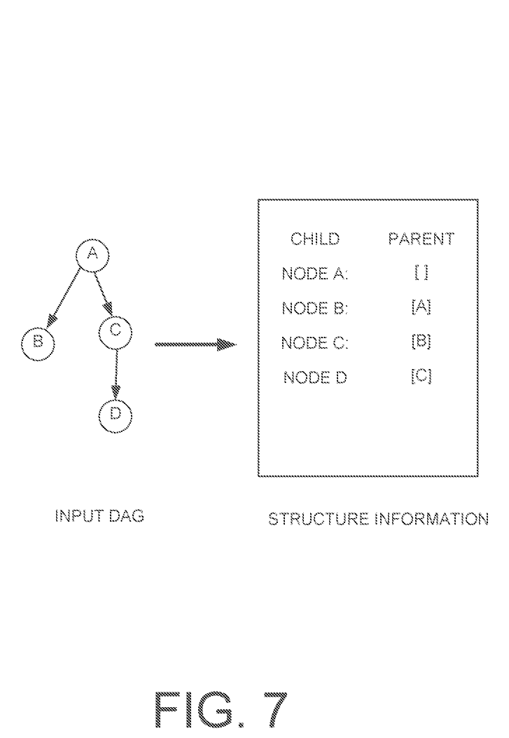

Post generating the non-linear relationship at block 306, at block 402 of FIG. 4, the method includes generating a Directed Acyclic Graph (DAG) for the asset based on the non-linear relationship. The DAG identifies pairs of child-parent nodes, where child nodes are associated with operational output variables, and parent nodes are associated with operational input variables. This DAG structure is designed to model and represent complex relationships between input and output variables in an asset's operational data. The use of a DAG suggests a sophisticated approach to analyzing cause-and-effect relationships or dependencies within the system being described. The use of a Directed Acyclic Graph (DAG) provides a clear visual representation of the causal relationships between operational input and output variables. This structure not only aids in understanding the asset's behavior but also facilitates efficient inference and anomaly detection processes. The DAG's hierarchical arrangement of nodes enables the system to capture and analyze complex dependencies that may not be apparent in traditional linear models. In an example, the DAG is generated for identifying the plurality of pairs of nodes in a hierarchical order representing the root node with highest rank. The root node, positioned at the top of the hierarchy, is identified as the node with the highest rank based on these criteria. As the anomaly detection engine 106 progresses through the DAG, it identifies pairs of nodes that are directly connected or closely related within the hierarchical structure. These pairs are organized in descending order of importance, with pairs closer to the root node generally having higher priority. This hierarchical ordering of node pairs enables the anomaly detection system to focus on the most significant relationships and patterns within the data. By leveraging the hierarchical structure of the DAG and the ranked pairs of nodes, unusual patterns, outliers, or deviations from expected behavior within the analyzed data set can be effectively identified. In an example, the DAG may be generated by implementing a data-based DAG learning model. The data-based DAG learning model is to implement time-series discretization techniques for use of the DAG in categorical datasets. The data-based DAG learning model includes components such as an Equal Width Discretization (EWD) module, a Hill Climb (HC) search algorithm, and a Bayesian Information Criterion (BIC) scoring module. Such a structural representation of input DAG can be seen in FIG. 7. In FIG. 7, the input DAG includes 4 nodes A, B, C, and D. Node A represents a root node with highest rank and no parent node. The structure information indicates the child-parent relationship of the nodes A, B, C, and D.

Returning to FIG. 3, at block 308, the method includes generating a non-linear inference based on the non-linear relationship. In an example, the non-linear inference may be generated by a prespecified Extreme Learning Machine (ELM). In an example, the prespecified ELM, includes, but is not limited to, Sequential Domain-Adaptation Extreme Learning Machine (SDAELM), Domain Adaptation Extreme Learning Machine (DAELM), Sequential Regularized Extreme Learning Machine (SRELM), and Regularized Extreme Learning Machine (RELM). The prespecified ELM uses feedforward neural networks to perform a variety of tasks, including classification, regression, clustering, etc. The implementation of prespecified ELM variants, particularly the Sequential Domain Adaptation Extreme Learning Machine (SDAELM), addresses key challenges in industrial anomaly detection. These challenges include limited initial data, the need for real-time adaptability, and the requirement to generalize across different operational domains. The SDAELM's ability to perform online learning and adapt to new environments with minimal data makes it particularly suited for dynamic industrial settings where operational conditions may frequently change. In an example, the non-linear relationship may be normalized using the prespecified ELM to represent predicted operational condition of the asset. The normalized non-linear relationship is used to generate a predictive model that forecasts future operational conditions of the asset based on current and historical data, enabling proactive maintenance and optimization of asset performance.

For example, the prespecified ELM adapts the concept of domain adaptation, which is particularly valuable in scenarios with limited data, such as for the anomaly detected based on the initial operational input data. The prespecified ELM can adapt to new environments with minimal data by leveraging data from related domains, improving robustness and accuracy. The sequential nature of the prespecified ELM enables online learning, allowing for real-time updates and adaptability in industrial applications. Such prespecified ELM based model can continuously learn and adjust as new data becomes available, maintaining relevance and effectiveness over time. The flexibility is also offered through four different working modes (SDAELM, DAELM, SRELM, and RELM) by toggling sequential learning. This flexibility allows practitioners to choose the most suitable mode based on specific problem requirements, whether it requires full domain adaptation with sequential learning or a simpler regularized ELM.

For generating the non-linear inference, the prespecified ELM may transfer behavioral uncertainties on a child node present in the pair of child-parent nodes of each of the pairs of nodes. Behavioral uncertainties refer to the variability or unpredictability in the asset's behavior under different operating conditions. In the present context, such uncertainties may be associated with the nodes in the model representing operational output data. The prespecified ELM may be trained on the non-linear plurality inference and historical operational data associated with a normal operational behavior of the asset. Normal operational behavior refers to the expected range of values and patterns observed in the asset or process when it is functioning correctly and efficiently. This baseline is established using historical operational data collected during periods of known good performance. The transfer of the behavioral uncertainties from parent nodes to child nodes in the DAG allows for a more nuanced and context-aware anomaly detection process. This transfer of uncertainties, facilitated by the prespecified ELM, enables the system to consider the propagation of potential anomalies through the asset's operational structure, leading to more accurate and interpretable results. In an example, the behavioral uncertainties may be associated at the operational output variables, by the prespecified ELM, through prediction intervals generated by a sampling technique. In an example, the DAG may be implemented as a structural learning component of the probabilistic graphical model. In an example, the structural learning component is configured to identify causal relationships between variables and further determine conditional dependencies among the variables based on the identified causal relationships.

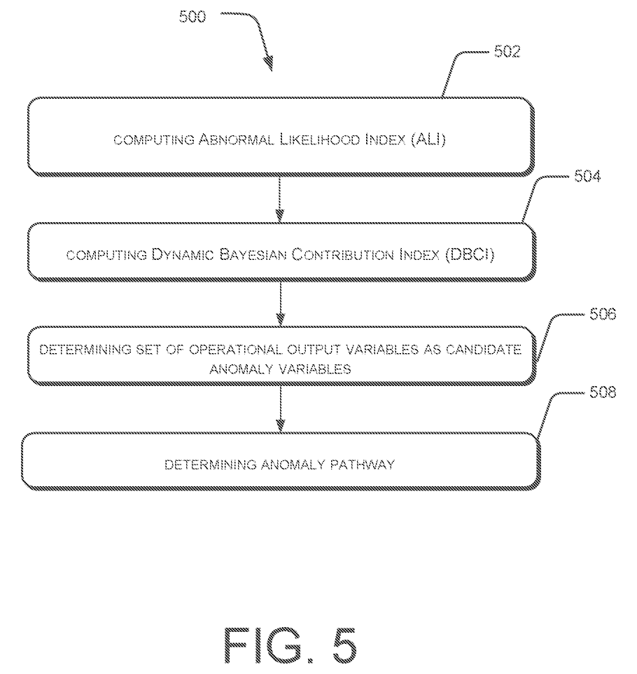

At block 310, the method includes parsing the non-linear inference to determine deviations in the behavioral uncertainties from the historical operational data beyond a prespecified threshold for detecting an anomaly in the asset. In an example, the anomaly is determined based on a deviation in the behavioral uncertainties of the child node from the normal operational behavior of the asset. For detecting the anomaly, the non-linear inference is parsed through the prespecified ELM. During the parsing, the non-linear inference may be compared with a predetermined threshold to determine the anomaly in the operational behavior of the asset. The anomaly detection is the process of identifying unusual patterns or behaviors in the system that deviate significantly from the expected normal operational behavior. For example, anomalies may be detected by comparing the current behavioral uncertainties, as inferred by the prespecified ELM, against the historical data and predefined thresholds. Anomaly detection is further illustrated in FIG. 5. FIG. 5 illustrates determination of anomaly pathway, according to an example.

At block 502, the method includes computing an Abnormal Likelihood Index (ALI). The ALI may be computed by the anomaly detection engine 106, to quantify the deviation in the behavioral uncertainties from the normal operational behavior of the asset and further a Dynamic Bayesian Contribution Index (DBCI) is computed at block 504 to analyze contributions of the operational output variables to the anomaly. The Abnormal Likelihood Index (ALI) is a quantitative measure that assesses the degree of deviation in behavioral uncertainties from the asset's normal operational state. The ALI is computed using statistical methods to compare current operational data against established baseline patterns. The Dynamic Bayesian Contribution Index (DBCI) is probabilistic metric that evaluates the relative contributions of various operational output variables to an observed anomaly. The DBCI is calculated using Bayesian inference techniques, allowing for dynamic updating of probabilities as new data becomes available.

Further at block 506, the method includes determining a set of the operational output variables as candidate anomaly variables based on the DBCI. The set is associated with child nodes present in the plurality of pairs of nodes. The candidate anomaly variables may be a subset of operational output variables identified based on their DBCI values, indicating a high likelihood of being associated with the detected anomaly. These variables correspond to child nodes in the DAG representation. In an example, post anomaly detection, an alert signal indicative of the anomaly may be generated when the non-linear inference exceeds the predetermined threshold. The alert signal is a notification or warning of the detected anomaly. The alert signals based on detected anomalies enables proactive maintenance and operational management.

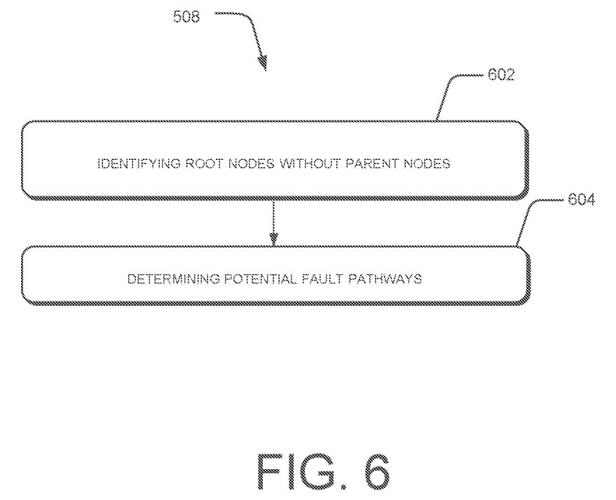

At block 508, the method includes determining anomaly pathway. For determining the anomaly pathway, a root cause is diagnosed for the anomaly. Such a root cause diagnosis is illustrated in FIG. 6.

At block 602, the method includes identifying root nodes without parent nodes. For the child node for which the anomaly is ascertained, in an example the root cause diagnosis engine 108 determines a root node among the pairs of nodes for diagnosing root cause of the anomaly. The root node is without a parent node. That is to say, a root node is a node in the DAG that has no parent nodes, representing a fundamental input variable that is not influenced by other variables in the model. During the toot cause diagnosis, the fundamental source or origin of an observed anomaly or problem is identified. The root cause diagnosis may be performed by tracing back through the DAG structure to identify the parent nodes (variables) that are most likely responsible for the observed deviation in a child node.

At block 604, the method includes determining potential fault pathways. For this, an anomaly pathway may be determined from the DAG. The anomaly pathway represents a sequence of connected nodes in the DAG that represents the propagation of an anomaly through the system, from root causes to observable effects. The determination is done by firstly identifying root nodes without parent nodes as immediate candidates for anomaly. Further, for the candidate anomaly variables with parent nodes, potential fault pathways are determined to identify root nodes. The determination of the potential fault pathways is the determination of potential routes through the DAG that an anomaly may follow, starting from candidate anomaly variables and tracing back to root nodes. Such concepts are applied to systematically analyze the DAG structure, identifying potential sources of anomalies and tracing their propagation through the structure information. This approach enables efficient and accurate identification of root causes, facilitating targeted interventions and maintenance actions.

By combining the elements, i.e., DAG, BBN, GBN, ELM, a powerful and flexible approach may be provided for monitoring complex industrial processes, detecting anomalies early, and quickly identifying root causes of issues. This approach enables more efficient maintenance, reduced downtime, and improved overall performance of assets in OT environments. Also, the root cause diagnosis utilizes a combination of statistical analysis, machine learning techniques, and domain-specific knowledge to refine its diagnosis. This multi-faceted approach enables the engine to handle complex scenarios where the root cause may not be immediately apparent or may be the result of multiple interacting factors. For example, for determining the root node, the pairs of nodes may be traversed from the root node to the child node for which the anomaly is ascertained. This traversal allows analysis of the relationships and dependencies between nodes, potentially identifying factors contributing to the anomaly. During the traversal, various attributes and metrics associated with each node may also be examined. These may include performance indicators, configuration settings, resource utilization, and any other relevant data points that could provide insights into the anomaly's origin.

In addition to traversing the DAG, temporal aspects of the data may also be considered. It analyzes time-series information to identify any patterns or trends that preceded the anomaly. This temporal analysis can reveal important insights into the sequence of events that led to the anomalous behavior, helping to pinpoint the root cause more accurately. Advanced algorithms and heuristics may be applied to evaluate the likelihood of each traversed node being the root cause of the anomaly. This evaluation takes into account historical data, known patterns, and predefined rules specific to the system or application being monitored. As the traversal progresses, a probability map or score may be built for each node, indicating its potential contribution to the anomaly. This allows for a more nuanced understanding of the problem, as multiple factors may be involved in causing or exacerbating the anomaly.

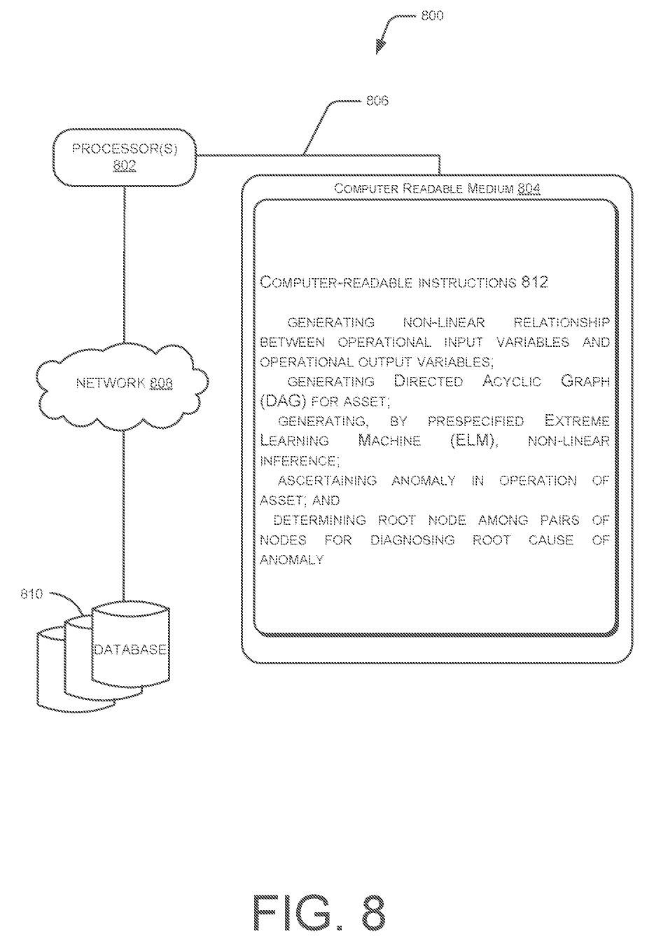

FIG. 8 illustrates a system environment 800 implementing a non-transitory computer readable medium for detecting anomalies and diagnosing root causes in assets operating in OT environments, according to an example. In an example, the system environment 800 includes processor(s) 802 communicatively coupled to a non-transitory computer readable medium 804 through a communication link 806. In an example, the processor(s) 802 may have one or more processing resources for fetching and executing computer-readable instructions from the non-transitory computer readable medium 804. The processor(s) 802 and the non-transitory computer readable medium 804 may be implemented, for example, in the system 100 (as has been described in conjunction with the preceding figures).

The non-transitory computer readable medium 804 may be, for example, an internal memory device or an external memory device. In an example implementation, the communication link 806 may be a network communication link. The processor(s) 802 may access the non-transitory computer readable medium 804 through a network 808. The network 808 may be a single network or a combination of multiple networks and may use a variety of communication protocols. The processor(s) 802 and the non-transitory computer readable medium 804 may also be communicatively coupled to a data source 810 over the network 808. The data source 810 may include, for example, a database.

In an example implementation, the non-transitory computer readable medium 804 includes a set of computer readable instructions (hereinafter may also be referred as instructions) 812 which may be accessed by the processor(s) 802 through the communication link 806. Referring to FIG. 8, in an example, the non-transitory computer readable medium 804 includes instructions 812 that may cause the processor(s) 802 to generate a non-linear relationship between operational input variables and operational output variables of an asset operating in an Operational Technology (OT) environment. The operational input variables influence the asset performance in a chosen output response. The operational output variables output response based on the operational input variables. The non-linear relationship may be represented by a curve and in the non-linear relationship, data elements, such as the operational input variables and the operational output variables of the asset are attached in hierarchically manner. In an example, the non-linear relationship between the operational input variables and the operational output variables may be generated using one of a Bayesian Belief Network (BBN) and a Gaussian Bayesian network (GBN).

The instructions 812 may cause the processor(s) 802 to generate a Directed Acyclic Graph (DAG) for the asset based on the non-linear relationship. The DAG is a visual representation of the non-linear relationship between the operational input variables and the operational output variables of the asset and their connection to each other. The DAG is structured to identify multiple pairs of nodes, with each pair representing a child-parent relationship. For example, the DAG identifies a plurality of pairs of nodes, each of the plurality of pairs of nodes identifies a pair of child-parent nodes. A child node in the pair of child-parent nodes is associated with the operational output variables. A parent node in the pair of child-parent nodes is associated with the operational input variables. Specifically, it outlines the generation of a Directed Acyclic Graph (DAG) for an asset based on a non-linear relationship. In this structure, child nodes are associated with operational output variables and parent nodes are associated with operational input variables. This DAG structure is designed to model and represent complex relationships between input and output variables in an asset's operational data. The use of a DAG suggests a sophisticated approach to analyzing cause-and-effect relationships or dependencies within the system being described. The DAG forms a structural learning part of the BBN or the GBN.

The instructions 812 may cause the processor(s) 802 to generate a non-linear inference by transferring behavioral uncertainties on at least one child node present in the pair of child-parent nodes of each of the pairs of nodes. In an example, the non-linear inference may be generated by a prespecified Extreme Learning Machine (ELM). In an example, the prespecified ELM, includes, but is not limited to, Sequential Domain-Adaptation Extreme Learning Machine (SDAELM), Domain Adaptation Extreme Learning Machine (DAELM), Sequential Regularized Extreme Learning Machine (SRELM), and Regularized Extreme Learning Machine (RELM). The ELM uses feedforward neural networks to perform a variety of tasks, including classification, regression, clustering, etc. In particular, when the Sequential Domain Adaptation Extreme Learning Machine (SDAELM) is implemented in place of a basic ELM model, the following critical technical advantages may be observed. For example, the SDAELM adapts the concept of domain adaptation, which is particularly valuable in scenarios with limited data, such as for the anomaly detected based on the initial operational input data. The SDAELM can adapt to new environments with minimal data by leveraging data from related domains, improving robustness and accuracy. The sequential nature of the SDAELM enables online learning, allowing for real-time updates and adaptability in industrial applications. Such specific ELM based model can continuously learn and adjust as new data becomes available, maintaining relevance and effectiveness over time. For generating the non-linear inference, the prespecified ELM assists in transferring behavioral uncertainties on a child node present in the pair of child-parent nodes of each of the pairs of nodes. In an example, the prespecified ELM may be trained on the non-linear plurality inference and historical operational data associated with a normal operational behavior of the asset. The non-linear inference may refer to predictions or estimations that do not follow a straight-line relationship.

Further, the instructions 812 may cause the processor(s) 802, to ascertain an anomaly in an operation of the asset. For this, a deviation may be determined in the behavioral uncertainties of the child node from the normal operational behavior of the asset. The anomaly is proportional to the deviation from expected or normal behavior. For detecting the anomaly, the non-linear inference is parsed through the prespecified ELM. In an example, an aggregated non-linear inference may be compared with a predetermined threshold to determine the anomaly in the operational behavior of the asset.

Further, the instructions 812 may cause the processor(s) 802, to determine a root node among the pairs of nodes for diagnosing root cause of the anomaly. In particular, for the child node for which the anomaly is ascertained, the root node may be determined among the pairs of nodes for diagnosing root cause of the anomaly. The root node is without a parent node. For determining the root node, the pairs of nodes are traversed from the root node to the child node for which the anomaly is ascertained. This traversal allows the engine to analyze the relationships and dependencies between nodes, potentially identifying factors contributing to the anomaly. Advanced algorithms and heuristics may be applied to evaluate the likelihood of each traversed node being the root cause of the anomaly. This evaluation takes into account historical data, known patterns, and predefined rules specific to the system or application being monitored. As the traversal progresses, a probability map or score may be generated for each node, indicating its potential contribution to the anomaly. This allows for a more nuanced understanding of the problem, as multiple factors may be involved in causing or exacerbating the anomaly.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A system comprising:
an anomaly detection engine to:
generate a non-linear relationship between operational input variables and operational output variables of an asset operating in an Operational Technology (OT) environment;
generate a Directed Acyclic Graph (DAG) for the asset based on the non-linear relationship, wherein the DAG identifies a plurality of pairs of nodes, each of the plurality of pairs of nodes identifies a pair of child-parent nodes, wherein a child node in the pair of child-parent nodes is associated with the operational output variables, and a parent node in the pair of child-parent nodes is associated with the operational input variables;
generate, by a prespecified Extreme Learning Machine (ELM), a non-linear inference by transferring behavioral uncertainties on at least one child node present in the pair of child-parent nodes of each of the pairs of nodes, wherein the prespecified ELM is trained on the non-linear inference and historical operational data associated with a normal operational behavior of the asset; and
ascertain an anomaly in an operation of the asset on determining a deviation in the behavioral uncertainties of the at least one child node from the normal operational behavior of the asset, wherein the non-linear inference is parsed through the prespecified ELM for detecting the anomaly; and
a root cause diagnosis engine to:
for the at least one child node for which the anomaly is ascertained, determine a root node among the pairs of nodes for diagnosing root cause of the anomaly, wherein the root node is without a parent node.

2. The system as claimed in claim 1,
wherein the anomaly detection engine is to:
compute an Abnormal Likelihood Index (ALI) to quantify the deviation in the behavioral uncertainties from the normal operational behavior of the asset;
compute a Dynamic Bayesian Contribution Index (DBCI) to analyze contributions of the operational output variables to the anomaly; and
determine a set of the operational output variables as candidate anomaly variables based on the DBCI, wherein the set is associated with child nodes present in the plurality of pairs of nodes; and
wherein the root cause diagnosis engine is to:
determine an anomaly pathway from the DAG by:
identifying root nodes without parent nodes as immediate candidates for anomaly, and
for the candidate anomaly variables with parent nodes, determining potential fault pathways to identify root nodes.

3. The system as claimed in claim 1, wherein the anomaly detection engine is to generate the DAG for identifying the plurality of pairs of nodes in a hierarchical order representing the root node with highest rank.

4. The system as claimed in claim 1, wherein the prespecified ELM is one of Sequential Domain-Adaptation Extreme Learning Machine (SDAELM), Domain Adaptation Extreme Learning Machine (DAELM), Sequential Regularized Extreme Learning Machine (SRELM), and Regularized Extreme Learning Machine (RELM).

5. The system as claimed in claim 1, wherein the anomaly detection engine is to implement a probabilistic graphical model to perform a causality analysis for generating the non-linear relationship between the operational input variables and the operational output variables.

6. The system as claimed in claim 5, wherein the probabilistic graphical model is one of a Bayesian Belief Network (BBN) and a Gaussian Bayesian network (GBN).

7. The system as claimed in claim 1, wherein the anomaly detection engine is to normalize, by the prespecified ELM, the non-linear relationship to represent predicted operational condition of the asset.

8. The system as claimed in claim 5, wherein the probabilistic graphical model is embedded with the prespecified ELM for anomaly detection.

9. The system as claimed in claim 5, wherein the anomaly detection engine is to implement the DAG as a structural learning component of the probabilistic graphical model.

10. A method comprising:
obtaining operational input variables corresponding to an asset operating in an Operational Technology (OT) environment;
obtaining operational output variables indicating an effect on the asset as a function of the operational input variables;
generating a non-linear relationship between the operational input variables and the operational output variables;
generating, by a prespecified Extreme Learning Machine (ELM), a non-linear inference based on the non-linear relationship, wherein the non-linear inference is to associate behavioral uncertainties at the operational output variables, wherein the prespecified ELM is trained on the non-linear inference and historical operational data associated with a normal operational behavior of the asset; and
parsing the non-linear inference, through the prespecified ELM, to determine deviations in the behavioral uncertainties from the historical operational data beyond a prespecified threshold for detecting an anomaly in the asset.

11. The method as claimed in claim 10, further comprising generating a Directed Acyclic Graph (DAG) for the asset based on the non-linear relationship, wherein the DAG identifies a plurality of pairs of nodes, each of the plurality of pairs of nodes identifies a pair of child-parent nodes, wherein a child node in the pair of child-parent nodes is associated with the operational output variables, and a parent node in the pair of child-parent nodes is associated with the operational input variables.

12. The method as claimed in claim 11, wherein the DAG is generated by implementing a data-based DAG learning model, wherein the data-based DAG learning model is to implement time-series discretization techniques for use of the DAG in categorical datasets.

13. The method as claimed in claim 12, wherein the data-based DAG learning model comprises:
an Equal Width Discretization (EWD) module;
a Hill Climb (HC) search algorithm; and
a Bayesian Information Criterion (BIC) scoring module.

14. The method as claimed in claim 10, further comprising:
computing an Abnormal Likelihood Index (ALI) to quantify the deviations in the behavioral uncertainties from the normal operational behavior of the asset;
computing a Dynamic Bayesian Contribution Index (DBCI) to analyze contributions of the operational output variables to the anomaly;
determining a set of the operational output variables as candidate anomaly variables based on the DBCI, wherein the set is associated with child nodes present in the plurality of pair of nodes; and
determining an anomaly pathway from the DAG by:
identifying root nodes without parent nodes as immediate candidates for anomaly, and
for the candidate anomaly variables with parent nodes, determining potential fault pathways to identify root nodes.

15. The method as claimed in claim 10, wherein the behavioral uncertainties are associated at the operational output variables, by the prespecified ELM, through prediction intervals generated by a sampling technique.

16. The method as claimed in claim 10, wherein the prespecified ELM is one of Sequential Domain-Adaptation Extreme Learning Machine (SDAELM), Domain Adaptation Extreme Learning Machine (DAELM), Sequential Regularized Extreme Learning Machine (SRELM), and Regularized Extreme Learning Machine (RELM).

17. The method as claimed in claim 10, wherein the non-linear relationship between the operational input variables and the operational output variables is generated using one of a Bayesian Belief Network (BBN) and a Gaussian Bayesian network (GBN).

18. A non-transitory computer readable medium having instructions stored thereon, the instructions, when executed by a processor, cause the processor to perform operations comprising:
generating a non-linear relationship between operational input variables and operational output variables of an asset operating in an Operational Technology (OT) environment;
generating a Directed Acyclic Graph (DAG) for the asset based on the non-linear relationship, wherein the DAG identifies a plurality of pairs of nodes, each of the plurality of pairs of nodes identifies a pair of child-parent nodes, wherein a child node in the pair of child-parent nodes is associated with the operational output variables, and a parent node in the pair of child-parent nodes is associated with the operational input variables;
generating, by a prespecified Extreme Learning Machine (ELM), a non-linear inference by transferring behavioral uncertainties on at least one child node present in the pair of child-parent nodes of each of the pairs of nodes, wherein the prespecified ELM is trained on the non-linear inference and historical operational data associated with a normal operational behavior of the asset;
ascertaining an anomaly in an operation of the asset on determining a deviation in the behavioral uncertainties of the at least one child node from the normal operational behavior of the asset, wherein the non-linear inference is parsed through the prespecified ELM for detecting the anomaly; and
for the at least one child node for which the anomaly is detected, determining a root node among the pairs of nodes for diagnosing root cause of the anomaly, wherein the root node is without a parent node.

19. The non-transitory computer readable medium as claimed in claim 18, wherein the non-linear relationship between the operational input variables and the operational output variables is generated using one of a Bayesian Belief Network (BBN) and a Gaussian Bayesian network (GBN)

20. The non-transitory computer readable medium as claimed in claim 18, wherein the prespecified ELM is one of Sequential Domain-Adaptation Extreme Learning Machine (SDAELM), Domain Adaptation Extreme Learning Machine (DAELM), Sequential Regularized Extreme Learning Machine (SRELM), and Regularized Extreme Learning Machine (RELM).
